(19) United States
(12) Patent Application Publication
(10) Pub. No.: US 2018/0115226 A1
(43) Pub. Date: Apr. 26, 2018

(54) METHOD AND SYSTEM FOR MONITORING MOTOR BEARING CONDITION

(71) Applicant: General Electric Company, Schenectady, NY (US)

(72) Inventors: Hua Zhang, Greer, SC (US); David Terry Trayhan, JR., Greenville, SC (US); Iris Ziqin Hu, Greer, SC (US)

(21) Appl. No.: 15/333,331

(22) Filed: Oct. 25, 2016

(51) Int. Cl. H02K 15/00; H02K 7/08; H02K 9/02; G01N 29/46; G01N 29/44; G01M 13/04

(52) U.S. Cl. CPC H02K 15/0006; H02K 7/08; H02K 9/02; G01N 2291/023; G01N 29/4463; G01M 13/045; G01N 29/4418; G01N 29/46

(57) ABSTRACT

A system includes an industrial machine that includes a motor and a motor bearing. The system also includes multiple acoustic sensors disposed adjacent the industrial machine. The system further includes multiple other sensors disposed adjacent the industrial machine. The system even further includes a controller programmed to receive noise signals representative of a noise made by the motor bearing acquired by the multiple acoustic sensors, to receive signals representative of operational conditions of the industrial machine, to analyze the noise signals to determine characteristics of the noise, to analyze the characteristics of the noise utilizing the operational conditions, to compare the characteristics of the noise to a plurality of models associated with different noises made by the motor bearing that are associated with a particular abnormal operation, and to select a model from the plurality of models that matches the characteristics of the noise.

### BACKGROUND

The subject matter disclosed herein relates to industrial machines, and more specifically, to a system and method for monitoring a motor bearing condition of a motor bearing of an industrial machine.

Power plants typically include numerous industrial or power machines driven by motors. Each of these motors may include at least one motor bearing. These motor bearings are supposed to be regularly subject to maintenance. However, these motor bearings may not receive necessary maintenance, which may result in equipment malfunction and loss of time and money.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In accordance with an embodiment, a system includes an industrial machine that includes a motor and a motor bearing. The system also includes multiple acoustic sensors disposed adjacent the industrial machine. The system further includes multiple other sensors disposed adjacent the industrial machine. The system even further includes a controller programmed to receive noise signals representative of a noise made by the motor bearing acquired by the multiple acoustic sensors, to receive signals representative of operational conditions of the industrial machine, to analyze the noise signals to determine characteristics of the noise, to analyze the characteristics of the noise utilizing the operational conditions, to compare the characteristics of the noise to a plurality of models associated with different noises made by the motor bearing that are associated with a particular abnormal operation, and to select a model from the plurality of models that matches the characteristics of the noise.

In accordance with an embodiment, a system includes multiple industrial machines, wherein each industrial machine of multiple machines includes a motor and a motor bearing. The system also includes multiple acoustic sensors disposed adjacent each industrial machine of the multiple industrial machines. The system further includes a controller programmed to receive noise signals representative of a noise made by a respective motor bearing of a respective industrial machine acquired by the multiple acoustic sensors adjacent the respective motor bearing, to analyze the noise signals to determine spectral characteristics of the noise, and to determine if the respective motor bearing needs maintenance based on the spectral characteristics of the noise.

In accordance with an embodiment, a controller includes a processor and a memory encoding one or more processor-executable routines, wherein the one or more routines, when executed be the processor, cause the controller to receive, from multiple acoustic sensors adjacent a motor bearing of an industrial machine, noise signals representative of a noise made by the motor bearing, to analyze the noise signals to determine spectral characteristics of the noise, to determine when the motor bearing needs maintenance based on spectral characteristics of the noise, and to provide a recommendation for maintenance of the motor bearing.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic view of an embodiment of a power plant that monitors industrial machines for conditions of the motor bearings;

FIG. 2 is a schematic view (e.g., side view) of an embodiment of an industrial machine (e.g., having a motor, motor bearing, and fan) coupled to a system for monitoring a condition of the motor bearing;

FIG. 3 is a schematic view (e.g., top view) of the industrial machine of FIG. 2;

FIG. 4 is a flow chart of an embodiment of a method for monitoring a condition of a motor bearing; and

FIG. 5 is a flow chart of an embodiment of a method for analysis of noise signals and monitoring a condition of a motor bearing.

### DETAILED DESCRIPTION

One or more specific embodiments of the present subject matter will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present subject matter, the articles “a,” “an,” “the,” and “said” are intended to mean that there are one or more of the elements. The terms “comprising,” “including,” and “having” are intended to be inclusive and mean that there may be additional elements other than the listed elements.

As described in further detail below, systems and methods are provided for monitoring and diagnosing the conditions of motor bearings for industrial machines. For example, acoustic sensors (e.g., microphones, Piezeo-electric accelerometers, microelectromechanical system (MEMS) sensors, surface acoustical wave sensors (SAW) Hall effect sensors, magnetostrictive sensor, bulk acoustical wave sensor, and etc.) may be utilized to detect characteristics of a noise originating from a motor bearing of an industrial machine. Characteristics (e.g., location, direction, noise spectrum, etc.) of the noise (based on the analysis of signals from the acoustic sensors) may be determined and certain characteristics compared to different models. Characteristics of the noise originating from the motor bearing may be further analyzed utilizing operational conditions of the industrial machine derived from other sensors (e.g. motor power meter, motor current meter, speed sensors, etc.). The different models may each include specific characteristics related to a specific condition (e.g., normal operation or abnormal operation) of the motor bearing. Based on the comparison of the characteristics of the noise to the different models, a model may be selected related to a particular condition. Based on the selected model, a recommendation (e.g., for maintenance), a control action or an alert may be provided related to the motor bearing if it is experiencing abnormal operation. The systems and methods may improve maintenance scheduling, enable preventive maintenance to be performed, and improve the reliability of the power plant (e.g., by reducing unplanned outages).

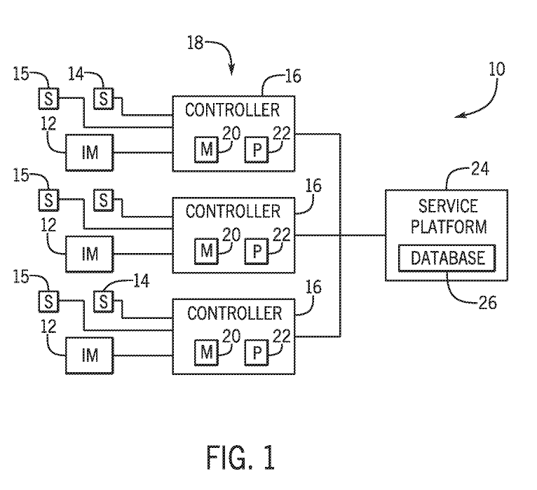

FIG. 1 is a schematic view of an embodiment of a power plant 10 that monitors industrial machines 12 for conditions of the motor bearings. The industrial machines 12 each include a motor and a motor bearing. In certain embodiments, one or more of the industrial machines 12 may include a fan (e.g., air cooled heat exchanger cooling fan). Examples of industrial machines 12 may include a compressor (e.g., fuel gas compressor), pumps (e.g., for water injection, wet compression, evaporative cooler, inlet chilling coolant circulation, water washing, liquid fuel, etc.), blowers (e.g., for enclosure ventilation), fans for cooling systems (e.g., exhaust frame cooling, condenser cooling, water cooling, etc.), and any other type of machine that may include a motor and a motor bearing. The respective motor bearings of the industrial machines 12 require regular maintenance (e.g., greasing of the bearing, or other procedure to make sure machine normal operations) to avoid failure of the power plant 10 and/or unplanned outages.

One or more sensors 14 (e.g., acoustic sensors) are disposed adjacent the industrial machine, in particular, the motor bearing. The number of sensors 14 may vary between 1 and 10 or any other number. In certain embodiments, at least two sensors 14 may be utilized per motor bearing in determining a location of a noise. In certain embodiments, at least three sensors 14 may be utilized in determining components (e.g., direction) of a noise (e.g., via triangulation). In certain embodiments, the sensors 14 may be arranged in specific pattern that enables background noise to be removed or filtered out. The sensors 14 may be coupled to the industrial machine 12 (e.g., adjacent the motor and motor bearing) or components adjacent the industrial machine 12. The sensors 14 are configured to detect a noise (or noises) generated by the respective motor bearing and/or fan. The sensors 14 may include microphones, Piezeo-electric accelerometers, MEMS sensors, Hall effect sensor, a magnetostrictive sensors, motor power meter, motor current meter, a surface acoustical wave sensor, a bulk wave sensor or any other type of sensor configured to detect noise. In certain embodiments, other sensors 15 (e.g., motor power meter, motor current meter, speed sensor, etc.) may be disposed adjacent or within the industrial machine (e.g., adjacent the motor and/or motor bearing). The sensors 15 may detect operational conditions of the industrial machine that may be utilized in analyzing characteristics of the noise (e.g., analyzing the noise spectrum). For example, noise frequency may be related to motor speed, while a vibration magnitude may be partially related to a power level (e.g., current level).

The industrial machines 12 and sensors 14, 15 are coupled to a respective controller 16 (or the same controller 16). The controllers 16 may be integrated into the power plant's distributed control system 18. Each controller 16 includes a memory 20 (e.g., a non-transitory computer-readable medium/memory circuitry) communicatively coupled to a processor 22. Each memory 20 stores one or more sets of instructions (e.g., processor-executable instructions) implemented to perform operations related to the respective industrial machine(s) 12 and/or monitoring of the condition (e.g., transient state) of the motor bearing(s), machines speed, motor current draw, and etc. More specifically, the memory 20 may include volatile memory, such as random access memory (RAM), and/or non-volatile memory, such as read-only memory (ROM), optical drives, hard disc drives, or solid-state drives. Additionally, the processor 22 may include one or more application specific integrated circuits (ASICs), one or more field programmable gate arrays (FPGAs), one or more general-purpose processors, or any combination thereof. Furthermore, the term processor is not limited to just those integrated circuits referred to in the art as processors, but broadly refers to computers, processors, microcontrollers, microcomputers, programmable logic controllers, application specific integrated circuits, and other programmable circuits. Each controller 16 is coupled to service platform 24. The service platform 24 may be a software platform for collecting data from the industrial machines 12. In certain embodiments, the service platform 24 maybe a cloud-based platform such as a service (PaaS). In certain embodiments, the service platform 24 may perform industrial-scale analytics to analyze performance of and optimize operation of both the power plant 10 and each component (e.g., industrial machines 12) of the power plant 10. The service platform 24 is coupled to a database 26 that includes different models associated with different conditions (normal and abnormal operation) of the motor bearing and motor speed, motor current, and correlations among them. Each model may include a different noise spectrum associated with a specific condition of the particular motor bearing (e.g., normal bearing operation or abnormal bearing operation (e.g., due to insufficient greasing of bearing, unusual wear, rust corrosion, creeping, skewing, misalignment, etc.)) as related to motor speed, motor current draw, ambient conditions, such as temperature and humidity. The models may be based on a hardware physical model of the specific motor bearing.

The controller 16 receives one or more signals (e.g., noise signals) representative of a noise made by a respective motor bearing of a respective industrial machine 12 (as well as background noise) from the sensors 14. The controller 16 may also receive signals representative of operational conditions (e.g., motor speed, motor current, etc.) of the machine 12. The controller 16 utilizes the noise signals to determine characteristics of the noise such as location and direction. If the controller 16 receives signals from at least two sensors 14, it can determine the location of the noise. If the controller 16 receives signals from at least three sensors 14, it can determine components (e.g., direction) of the noise. The controller 16 utilizes the noise signals to determine a representative noise spectrum for the noise made by the respective motor bearing. In certain embodiments, the controller 16 utilizes one or more operational conditions received from the other sensors 15 to analyze the noise spectrum. For example, noise frequency may be related to motor speed, while a vibration magnitude may be partially related to a power level (e.g., current level). In certain embodiments (where noise signals are received from at least three sensors 14 arranged in a specific pattern to remove background noise), the controller 16 may utilize spectral analysis (e.g., via an algorithm) that utilizes phase data of a signature frequency or signature frequencies of a rotating motor bearing to filter out or remove background noise from the noise signals obtained from the sensors 14. In certain embodiments, the controller 16 may also identify and remove motor cooling fan blade spinning noise (i.e., background noise) from the noise generated by the motor bearing 30. Once the background noise is removed, the controller 16 may determine a representative noise spectrum of the noise generated by the motor bearing. In addition, the controller 16 determines the bearing or location of the noise. The controller 16 may receive the models (representative of specific noise spectrums associated with different conditions of the motor bearing, motor operation modes and ambient conditions) from the service platform 24. In certain embodiments, the models may be stored on the memory 20 of the controller 16. The controller 16 may compare the representative noise spectrum of the noise generated by the motor bearing to the noise spectrum of the different models to find a match associated with a specific condition (e.g., normal operation or abnormal operation of the motor bearing). Upon finding a match with a model for a specific condition, the controller 16 may output an action (e.g., provide a recommendation for maintenance, schedule specific maintenance for the bearing, alter a time, date, or type of maintenance for the bearing, provide an alert to an operator of the condition of the bearing, or a system control action if the failure is imminent). It should be noted that the acts performed by the controller 16 may also be performed by the distributed control system 18 and/or the service platform 24.

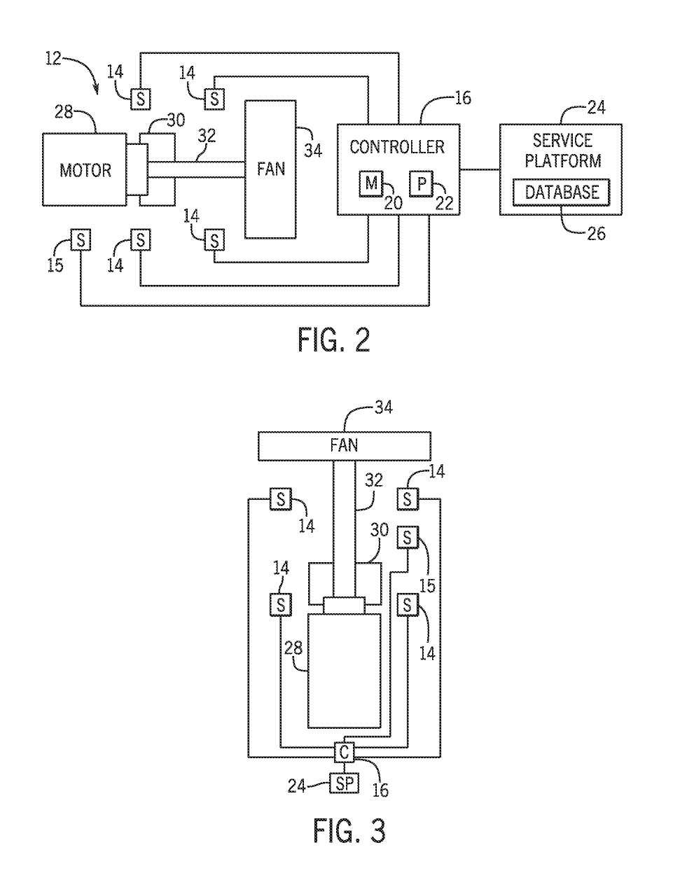

FIG. 2 is a schematic view (e.g., side view) of an embodiment of a specific industrial machine 12 coupled to a system for monitoring a condition of a motor bearing. As depicted, the industrial machine 12 includes a motor 28, a motor bearing 30 (e.g., disposed about a shaft 32), and a fan 34 (e.g., motor cooling fan) coupled to the motor 28 via the shaft 32. As depicted, the sensors 14, 15 (as described above) are disposed adjacent the industrial machine 12. In particular, the sensors 14 are disposed adjacent the motor bearing 30. As depicted, the sensors 14 are disposed in a specific pattern about the motor bearing 30 to enable the filtering out or removal of background noise (e.g., from the fan 34 or other sources) from the noise signals obtained from the sensors 14. The sensors 14 may be arranged in a pattern that enables determining the components of the noise as discussed above. The sensors 14 may be disposed at specific positions both above and below the motor bearing 30 as depicted in FIG. 2. In addition or alternatively, the sensors 14 may flank both sides of the motor bearing as depicted in FIG. 3. The sensors 14 operate in conjunction with the controller 16, the distributed control system 18, and/or the service platform 24 as described above and below to monitor the condition of the motor bearing 30.

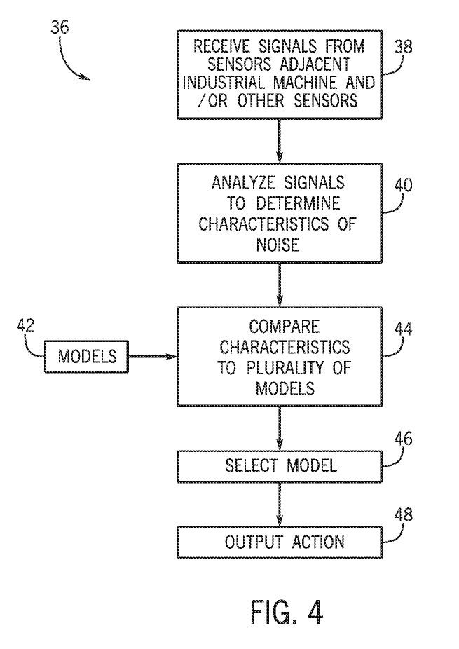

FIG. 4 is a flow chart of an embodiment of a method 36 for monitoring a condition of the motor bearing 30. One or more of the steps of the method 36 may be performed by the controller(s) 16, the distributed control system 18, the service platform 24, or a combination thereof. In addition, certain steps of the method 36 may be performed simultaneously. The method 36 includes receiving signals (e.g., noise signals) from sensors 14 (e.g., acoustic sensors) and/or signals from sensors 15 disposed adjacent the industrial machine 14 (in particular, the motor bearing 30) (block 38). The method 36 includes analyzing the signals to determine characteristics of the noise made by the motor bearing 30 (block 40). Determining characteristics of the noise may include determining a location, bearing, and/or a direction of the noise. In certain embodiments, determining characteristics of the noise may include obtaining a representative noise spectrum for the noise. In certain embodiments, one or more operational conditions received from the other sensors 15 may be utilized to analyze the noise spectrum. For example, noise frequency may be related to motor speed, while a vibration magnitude may be partially related to a power level (e.g., current level). In certain embodiments, spectral analysis may be performed to filter out or remove background noise from the noise signals obtained from the sensors 14. Spectral analysis may utilize phase data of a signature frequency or signature frequencies of the rotating motor bearing 30 to filter out or remove background noise from the noise signals. In certain embodiments, the method 36 may also include identifying and removing motor cooling fan blade spinning noise (i.e., background noise) from the noise signals. The method 36 further includes comparing the representative noise spectrum of the noise generated by the motor bearing 30 to the noise spectrum of different models 42 to find a match associated with a specific condition (e.g., normal operation or abnormal operation of the motor bearing 30) (block 44). The method 36 further includes selecting a model 42 (block 46) for a specific condition from the different models 42 based on matching the representative noise spectrum of the noise generated by the motor bearing 30 to the noise spectrum of a specific model associated with a specific condition (e.g., normal bearing operation or abnormal bearing operation (e.g., due to insufficient greasing of bearing, unusual wear, rust corrosion, creeping, skewing, misalignment, etc.)) as related to motor speed, motor current draw, and ambient conditions. Upon selecting the model 42 for a specific condition, the method 36 includes outputting an action (e.g., provide a recommendation for maintenance, schedule specific maintenance for the bearing, alter a time, date, or type of maintenance for the bearing, provide an alert to an operator of the condition of the bearing, or a control action to avoid machine faults if a failure is imminent) (block 48). The recommendation or alert may be provided to the operator via an output (e.g., speaker or screen) of a device (e.g., local or remote device) coupled to the controller 16, distributed control system 18, or service platform 24.

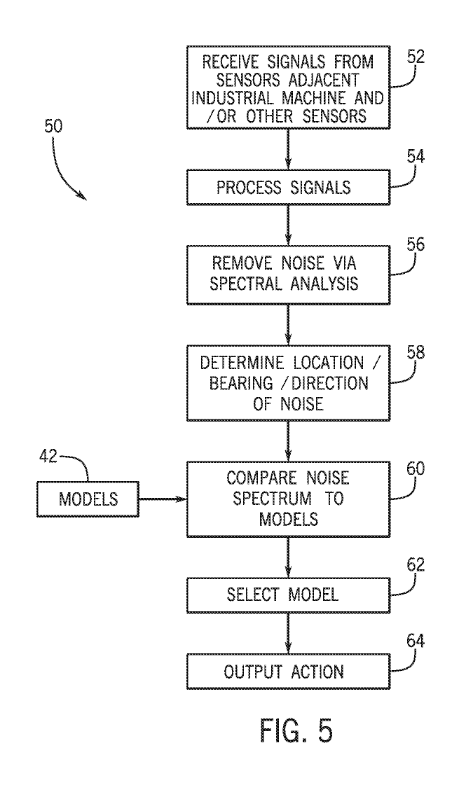

FIG. 5 is a flow chart of an embodiment of a method 50 for analysis of noise signals and monitoring a condition of the motor bearing 30. One or more of the steps of the method 50 may be performed by the controller(s) 16, the distributed control system 18, the service platform 24, or a combination thereof. In addition, certain steps of the method 50 may be performed simultaneously. The method 50 includes receiving signals (e.g., noise signals) from sensors 14 (e.g., acoustic sensors) and/or signals from sensors 15 disposed adjacent the industrial machine 14 (in particular, the motor bearing 30) (block 52). The method 50 also includes processing the noise signals (block 54). Processing may include performing Fast Fourier Transform on each noise signal (from each different sensor 14) to obtain a respective noise spectrum. The noise signals obtained by the sensors 14 may include background noise (e.g., from the spinning motor cooling fan 34 or other sources). The method 50 includes performing spectral analysis utilizing the noise spectra derived from the noise signals to remove or filter out background noise to obtain a noise spectrum representative of the noise generated by the motor bearing 30 (block 56). Spectral analysis utilizes the phase data of the signature frequency or signatures frequencies of the rotating motor bearing 30 to obtain the representative noise spectrum. In certain embodiments, one or more operational conditions received from the other sensors 15 may be utilized to analyze the noise spectrum. For example, noise frequency may be related to motor speed, while a vibration magnitude may be partially related to a power level (e.g., current level). The method 50 further includes comparing the representative noise spectrum of the noise generated by the motor bearing 30 to the noise spectrum of different models 42 to find a match associated with a specific condition (e.g., normal operation or abnormal operation of the motor bearing 30) (block 60). The method 50 further includes selecting a model 42 (block 62) for a specific condition from the different models 42 based on matching the representative noise spectrum of the noise generated by the motor bearing 30 to the noise spectrum of a specific model associated with a specific condition (e.g., normal bearing operation or abnormal bearing operation (e.g., due to insufficient greasing of bearing, unusual wear, rust corrosion, creeping, skewing, misalignment, etc.)). Upon selecting the model 42 for a specific condition, the method 50 includes outputting an action (e.g., provide a recommendation for maintenance, schedule specific maintenance for the bearing, alter a time, date, or type of maintenance for the bearing, provide an alert to an operator of the condition of the bearing) (block 64). The recommendation or alert may be provided to the operator via an output (e.g., speaker or screen) of a device (e.g., local or remote device) coupled to the controller 16, distributed control system 18, or service platform 24.

Technical effects of the disclosed embodiments include providing systems and methods for monitoring and diagnosing the conditions of motor bearings for industrial machines. For example, acoustic sensors along with a data eco-system, e.g. sensing data from other sensors, such as speed sensor, motor power meter, motor current meters and etc., may be utilized to detect characteristics of the noise originating from a motor bearing of an industrial machine. Characteristics (e.g., location, direction, noise spectrum, etc.) of the noise (based on the analysis of signals from the acoustic sensors) may be determined and certain characteristics compared to different models. The different models may each include specific characteristics related to a specific condition (normal or abnormal operation) of the motor bearing under normal or abnormal machine operation conditions. Based on the comparison of the characteristics of the noise to the different models, a model may be selected related to a particular abnormal operation. Based on the selected model, a recommendation (e.g., for maintenance) or an alert may be provided related to the motor bearing experiencing abnormal operation. The systems and methods may improve maintenance scheduling, enable preventive maintenance to be performed, prevent machine imminent failures to avoid hardware and system damage, and improve the reliability of the power plant (e.g., by reducing unplanned outages).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
an industrial machine comprising a motor and a motor bearing;
a plurality of acoustic sensors disposed adjacent the industrial machine;
a plurality of other sensors disposed adjacent the industrial machine; and
a controller programmed to receive noise signals representative of a noise made by the motor bearing acquired by the plurality of acoustic sensors, to receive signals representative of operational conditions of the industrial machine, to analyze the noise signals to determine characteristics of the noise, to analyze the characteristics of the noise utilizing the operational conditions, to compare the characteristics of the noise to a plurality of models associated with different noises made by the motor bearing that are associated with a particular abnormal operation, and to select a model from the plurality of models that matches the characteristics of the noise.

2. The system of claim 1, wherein the controller is programmed to provide a recommendation for maintenance of the motor bearing based on the selected model.

3. The system of claim 1, wherein the controller is programmed to remove background noise from the noise utilizing spectral analysis based on phase data of a signature frequency or frequencies of the motor bearing rotating derived from the noise signals.

4. The system of claim 3, wherein the plurality of acoustic sensors are arranged in a pattern that enables the controller to utilize the noise signals to remove the background noise from the noise.

5. The system of claim 1, wherein the controller is programmed to receive noise signals representative of the noise made by the motor bearing acquired by at least two acoustic sensors of the plurality of acoustic sensors and to analyze the noise signals to determine a location of the noise.

6. The system of claim 5, wherein the controller is programmed to receive noise signals representative of the noise made by the motor bearing acquired by at least three acoustic sensors of the plurality of acoustic sensors and to analyze the noise signals to determine a spectrum of the noise.

7. The system of claim 5, wherein each model of the plurality of models is associated with a noise spectrum associated with a particular problem with the motor bearing, and the controller is programmed to compare the spectrum of the noise to noise spectrums of each model of the plurality of models to select the model.

8. The system of claim 1, wherein the characteristics of the noise comprise spectral characteristics of the noise.

9. The system of claim 1, wherein the industrial machine comprises a motor cooling fan, and the controller is programmed to remove components associated with spinning of the motor cooling fan from the noise.

10. A system, comprising:
a plurality of industrial machines, wherein each industrial machine of the plurality of industrial machines comprises a motor and a motor bearing;
a plurality of acoustic sensors disposed adjacent each industrial machine of the plurality of industrial machines;
a controller programmed to receive noise signals representative of a noise made by a respective motor bearing of a respective industrial machine acquired by the plurality of acoustic sensors adjacent the respective motor bearing, to analyze the noise signals to determine spectral characteristics of the noise, and to determine if the respective motor bearing needs maintenance based on the spectral characteristics of the noise.

11. The system of claim 10, wherein the controller is programmed to compare the spectral characteristics of the noise to a plurality of models associated with different noises, wherein each model includes a unique noise spectrum made by the respective motor bearing associated with a particular abnormal operation.

12. The system of claim 11, wherein the controller is programmed to select a model from the plurality of models that matches the spectral characteristics of the noise.

13. The system of claim 12, wherein the controller is programmed to provide a recommendation for maintenance of the motor bearing based on the selected model.

14. The system of claim 11, wherein the controller is communicatively coupled to an industrial cloud-based service platform that comprises a database having the plurality of models.

15. The system of claim 11, wherein the controller is programmed to remove background noise from the noise utilizing spectral analysis based on phase data of a signature frequency or frequencies of the motor bearing rotating derived from the noise signals.

16. The system of claim 11, wherein the respective industrial machine comprises a motor cooling fan, and the controller is programmed to remove components associated with spinning of the motor cooling fan from the noise.

17. A controller, comprising:
a processor; and
a memory encoding one or more processor-executable routines, wherein the one or more routines, when executed by the processor, cause the controller to:
receive, from a plurality of acoustic sensors adjacent a motor bearing of an industrial machine, noise signals representative of a noise made by the motor bearing;
analyze the noise signals to determine spectral characteristics of the noise;
determine when the motor bearing needs maintenance based on the spectral characteristics of the noise; and
provide a recommendation for maintenance of the motor bearing.

18. The controller of claim 17, wherein the one or more routines, when executed by the processor, cause the controller to compare the spectral characteristics of the noise to a plurality of models associated with different noises, wherein each model includes a unique noise spectrum made by the motor bearing associated with a particular abnormal operation.

19. The controller of claim 18, wherein the one or more routines, when executed by the processor, cause the controller to select a model from the plurality of models that matches the spectral characteristics of the noise.

20. The controller of claim 18, wherein the one or more routines, when executed by the processor, cause the controller to provide the recommendation for maintenance of the motor bearing based on the selected model.
